(19) United States
(12) Patent Application Publication
(10) Pub. No.: US 2025/0297903 A1
(43) Pub. Date: Sep. 25, 2025

(54) SEGMENTED INTERFACES TO MINIMIZE IMPACT OF PARASITIC FORCES FOR STRAIN MEASUREMENT-BASED SENSOR

(71) Applicant: SENSATA TECHNOLOGIES, INC., ATTLEBORO, MA (US)

(72) Inventors: FRANK HENDRI JACOBS, BROEKLAND (NL); JAN-WILLEM SLOETJES, WIERDEN (NL); BART GOEDEGEBUURE, BORNE (NL); RENÉ BELD, LANGEVEEN (NL)

(21) Appl. No.: 18/860,211

(22) PCT Filed: May 12, 2023
(86) PCT No.: PCT/US2023/022041

§ 371 Date: Oct. 25, 2024

Related U.S. Application Data
(60) Provisional application No. 63/341,536, filed on May 13, 2022.

(51) Int. Cl. G01L 1/22; G01L 1/26; G01L 5/22

(52) U.S. Cl. CPC G01L 1/2268; G01L 1/2231; G01L 1/26; G01L 5/225

(57) ABSTRACT

In a particular embodiment, a sensing element that deforms in response to applications of forces to the force sensor apparatus, the sensing element including three or more defined contact features configured to interface with a counterpart; and one or more sensing gauges coupled to a top surface of the sensing element and configured to generate a signal indicating the degree that the sensing element deforms in response to the application of forces to the force sensor apparatus; wherein the sensing element includes three or more defined contact features that interface with a counterpart.

### BACKGROUND

Force sensors are often used to control or regulate a force that is applied to a component. In one type of force sensor, the force sensor is positioned in such a way that forces to be measured act on the sensor. The force sensor may be configured to transform a measurement of forces into an electrical signal for further use in the control or regulation of the forces. This type of force sensor may be used in a variety of applications, such as for measuring braking force of electromechanical brakes in automobiles. For example, a sensing element of the force sensor may be coupled to some component of the braking system and as forces are applied, the sensing element temporarily deforms. In this example, the strain on the sensing element may be measured and used to generate an electrical signal that is indicative of the forces acting on the component of the braking system.

### SUMMARY

Embodiments of the present disclosure minimize the impact of parasitic forces for strain measurement-based sensors by providing three or more contact features on a sensing element of a force sensor apparatus. The force sensor apparatus may be, for example, an electro-mechanical brake force sensor or a pedal force sensor. In some examples, the contact features are defined support contact interfaces on a sensor support structure of a sensing element. In other examples, a sensing element includes integration contact areas that interface with a counterpart during sensor integration are provided as the contact features. The contact features improve sensor accuracy by reducing the impact of parasitic forces on a strain-based measurement sensing element such as a sensing element that includes micro-fused strain gauges.

In a particular embodiment, a force sensor apparatus is disclosed that includes a sensing element that deforms in response to applications of forces to the force sensor apparatus, the sensing element including three or more defined contact features configured to interface with a counterpart. The force sensor apparatus also includes one or more sensing gauges coupled to a top surface of the sensing element and configured to generate a signal indicating the degree that the sensing element deforms in response to the application of forces to the force sensor apparatus. In some examples, the three or more defined contact features decouple integration forces from forces measured by force sensor apparatus. In some examples, the three or more defined contact features minimize an impact of parasitic forces. In some examples, the one or more sensing gauges are micro-fused strain gauges.

In some examples, the force sensor apparatus also includes a printed circuit board configured to receive the signal from the one or more sensing gauges. In some examples, the forces sensor apparatus also includes a support structure having a surface on which the printed circuit board is coupled, the support structure having an outer rim, the outer rim of the support structure attached to the sensing element. In some examples, the force sensor apparatus also includes a sensor housing that covers the printed circuit board, the sensor housing having an outer rim, the outer rim of the sensor housing attached to the sensing element.

In a particular embodiment, a method of assembling a force sensor apparatus is disclosed that includes electrically coupling electrical components of a printed circuit board (PCB) to a sensing element that deforms in response to applications of forces to the force sensor apparatus. In this example embodiment, the sensing element includes three or more defined contact features configured to interface with a counterpart. The method also includes coupling one or more sensing gauges to a top surface of the sensing element. The one or more sensing gauges are configured to generate a signal indicating the degree that the sensing element deforms in response to the application of forces to the force sensor apparatus.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A is a diagram illustrating an example electro-mechanical brake force sensor;

FIG. 1B is a diagram illustrating the electro-mechanical brake force sensor of FIG. 1A when integrated with a counterpart;

FIG. 2 is a diagram illustrating one example of a full circular press-fit sensing element;

FIG. 3A is a diagram illustrating a front view of a sensing element in accordance with some embodiment of the present disclosure;

FIG. 3B is a diagram illustrating an overhead view of the sensing element of FIG. 3A;

FIG. 4A is a diagram illustrating a partial cross-section view of a force sensor apparatus in accordance with some embodiments of the present disclosure;

FIG. 4B is a diagram illustrating a perspective view of the force sensor apparatus of FIG. 4A;

FIG. 4C is a diagram illustrating an overhead view of the force sensor apparatus of FIG. 4A;

FIG. 5A is a diagram illustrating an example pedal force sensor;

FIG. 5B is a diagram illustrating a sectional view the example pedal force sensor of FIG. 5A inserted in a fixture;

FIG. 5C is an example sensing element for the pedal force sensor of FIG. 5A;

FIG. 5D illustrates example undefine support contacts on the sensing element of FIG. 5C;

FIG. 6A is chart illustrating expected performance of a force sensor using the sensing element of FIG. 5C;

FIG. 6B is chart illustrating actual performance of a force sensor using the sensing element of FIG. 5C;

FIG. 6C is chart illustrating expected performance of a force sensor using the sensing element of FIG. 5C;

FIG. 6D is chart illustrating actual performance of a force sensor using the sensing element of FIG. 5C;

FIG. 7A is a diagram illustrating a perspective view of another sensing element in accordance with some embodiment of the present disclosure;

FIG. 7B is a diagram illustrating a perspective view of another force sensor apparatus, utilizing the sensing element of FIG. 7A, in accordance with some embodiments of the present disclosure;

FIG. 7C is a diagram illustrating an overhead view of the force sensor apparatus in FIG. 7B;

FIG. 8 is a flowchart to illustrate an implementation of a method for assembling a force sensor apparatus according to embodiments of the present disclosure;

### DETAILED DESCRIPTION

The advantages, and other features of the systems and methods disclosed herein, will become more readily apparent to those having ordinary skill in the art from the following detailed description of certain embodiments taken in conjunction with the drawings which set forth representative embodiments of the present invention.

In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Further, words defining orientation such as “upper”, “lower”, “inner”, and “outer” are merely used to help describe the location of components with respect to one another. For example, an “inner” surface of a part is merely meant to describe a surface that is separate from the “outer” surface of that same part. No words denoting orientation are used to describe an absolute orientation (i.e., where an “inner” part must always be inside a part).

Note that techniques herein are well suited for use in any type of sensor application such as force sensor assemblies as discussed herein. However, it should be noted that embodiments herein are not limited to use in such applications and that the techniques discussed herein are well suited for other applications as well.

The function of a pressure sensor is to transform the physical “fluid pressure” into a ratio-metric output voltage. This is achieved by using, for example, micro-fused strain gauges (MSG) to measure the strain field change on a sensing element due to the applied pressure. The same MSG technology can be used to measure forces as an applied force will also result into a strain field change on the sensing element of the sensor. Current MSG sensors have a uniform flat support or circular outer diameter. This is typically not a concern for a pressure sensor or a force sensor with additional integration part(s) to decouple integration forces from the sensing element.

An important difference between pressure sensors and force sensors is that pressure is a scalar and force is a vector. Since force is a vector, the force and support interfaces are much more important as they could impact the accuracy of the sensor. With the current trend of force sensors needing to become smaller for cost and integration reasons, the impact of parasitic forces on the sense element is a problem that is becoming increasingly difficult to solve.

To address these and other issues, embodiments of the present disclosure minimize the impact of parasitic forces for strain measurement-based sensors by providing three or more contact features on a support structure of the sensor. In some embodiments, defined support contact interfaces on a sensor support structure of a sensing element are provided as the contact features. In other embodiments, a sensing element includes integration contact areas that interface with a counterpart during sensor integration are provided as the contact features. The contact features improve sensor accuracy by reducing the impact of parasitic forces on a strain-based measurement sensing element such as a sensing element that includes micro-fused strain gauges.

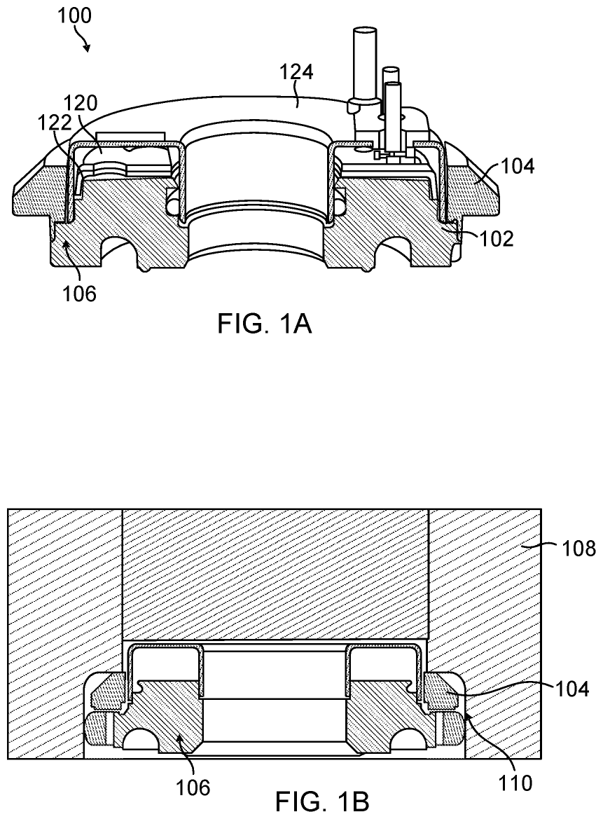

In some examples of force sensors, a brake force sensor is used for force measurement in the caliper of an Electro-Mechanical Brake (EMB) system. FIG. 1A illustrates an example of a EMB force sensor 100. The example EMB force sensor 100 includes a sensing element 102 and a reaction ring 104 coupled to an outer rim 106 of the sensing element 102. The example EMB force sensor may also include a printed circuit board 120, a support structure 122 for the printed circuit board 120, where the support structure 122 is coupled to one rim of the sensing element 102, and a sensor housing 124 that is coupled to another rim of the sensing element.

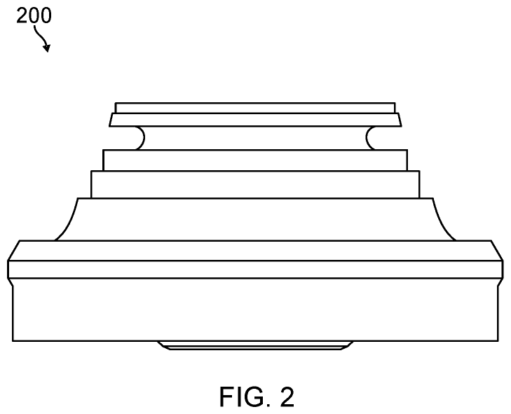

In some examples, the sensing element 102 includes micro-fused strain gauges (MSGs). The MSGs may be arranged in a Wheatstone bridge or other bridged circuit application. The sensing element may generate output signal for the full bridge circuit and half-bridge circuits. The reaction ring 104 decouples integration forces from the sensing element 102 when the sensor 100 is integrated with a counterpart component (e.g., a brake caliper). FIG. 2 illustrates the example EMB force sensor 100 when integrated in a brake caliper 108. The brake caliper 108 includes a housing 110 that interfaces with the reaction ring 104. The reaction ring 104 decouples forces applied by the caliper housing 110 or other structures of the caliper 108 that interface with the EMB sensor 100. As the reaction ring 104 is an expensive part, removing this reaction ring 104 will result in a much cheaper design. However, removing the reaction ring 104 means that another solution should be found to decouple the integration forces from the sensing element 102.

Due to integration, forces can act on the support/integration surfaces. This can be due to coefficient of thermal expansion (CTE) mismatches, but also due to the method of integration, such as making a press-fit between the sensor and counterpart. FIG. 2 depicts an example EMB sensor 200 utilizing a full circular press-fit. The use of a full circular press-fit can impact significantly on the sensor output.

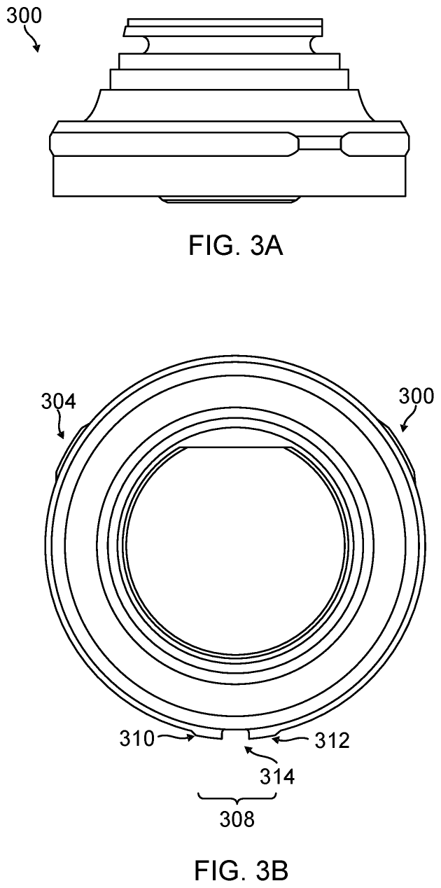

FIG. 3A is a diagram illustrating a sensing element 300 in accordance with some embodiments of the present disclosure. FIG. 3B sets forth an overhead view of the example sensing element 300. In some examples, the sensing element 300 is suitable for use in an EMB brake sensor apparatus as described above. The sensing element 300 is configured to deform in response to forces applied to the force sensor apparatus (e.g., the EMB brake sensor apparatus). In a particular embodiment, the sensing element 300 has a first surface arranged to receive a first force. The sensing element 300 deforms in response to the application of one or more forces on a force sensor apparatus. In a particular embodiment, the sensing element 300 is a piece of material, such as metal or plastic, that deforms in response to applications of forces. For example, the sensing element 300 may be a metal disk or a ring-shaped metal disk. The sensing element 300 may include one or more steps, rims, or lips (as depicted) for supporting stacked components such as a printed circuit board (PCB) support structure, sensor housing, or other components. Readers of skill in the art will realize that the sensing element 300 may be produced using a variety of methods and techniques including but not limited to turned and milled and metal injection molding.

The sensing element includes sensing gauges (not shown) coupled to the sensing element 300. In a particular embodiment, the top surface of the sensing element 300 is prepared to provide a good attachment surface for the sensing gauges. For example, the top surface of the sensing element 300 may be sand-blasted. Each of the sensing gauges is configured to generate a signal indicating the degree that the sensing element 300 deforms in response to the application of forces on the sensor. In a particular embodiment, the sensing gauges are micro-fused strain gauges (MSG). To measure the amount of force applied to the sensing element, the sensing gauges may be evenly distributed on a circle on a top surface of the sensing element 300. Readers of skill in the art will realize that any number of sensing gauges may be used in accordance with the present disclosure (including a particular embodiment in which a single gauge is used as the sensing gauges).

In some embodiments in accordance with the present disclosure, sensor error is reduced by minimizing the parasitic forces on the sensing element due to integration forces without using a reaction ring or other additional integration component, as is used in prior configurations. In contrast to using a reaction ring or other integration component, in embodiments of the present disclosure, the sensing element includes defined integration contact areas. The sensing element 300 includes a segmented press-fit feature instead of a full-circular press-fit structure. In one example, the segmented press-fit feature includes three or more defined segments. These segments include defined integration contact areas 304, 306, 308 that interface with a counterpart during integration. The defined (as opposed to undefined or not predetermined) integration contact areas may be placed such that the net integration forces on the sensing surface of the sensing element 300 are zero or near-zero, thus reducing the error in the MSG measurements. In some examples, the defined integration contact areas 304, 306, 308 protrude from an outer rim 320 of the sensing element 300. In one example, as depicted in FIG. 3B, at least one contact area 308 includes a first portion 310 and a second portion 312 separated by a gap 314. In this example, the first portion 310 and the second portion 312 are combined to form one integration contact area 308. In one example, the segmented press-fit sensing element reduces the impact error-producing forces. These three or more defined integration contact areas 304, 306, 308 are also beneficial if the case of CTE mismatches between sensor port material and counterpart material. Thus, by utilizing the three or more defined integration contact areas 304, 306, 308 of a smaller segmented support interface, and aligning them optimally to gauges, the integration effects for an EMB force sensor are minimized without adding integration parts or complex features or simply accepting a larger error.

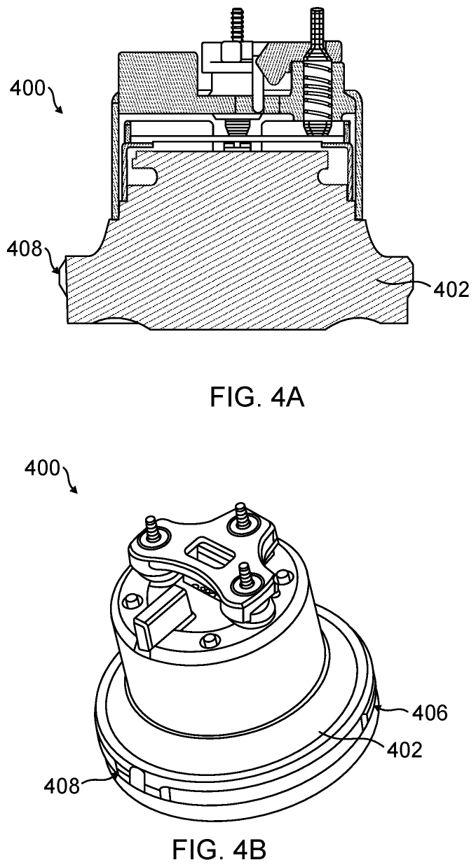

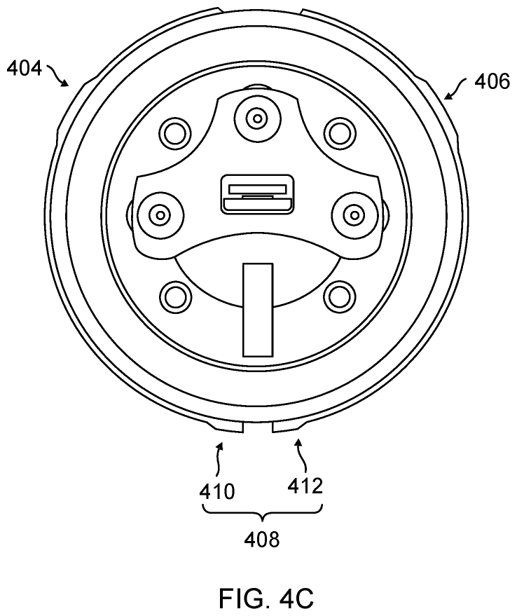

FIG. 4A illustrates a sectional view of an example segmented press-fit EMB force sensor 400 in accordance with some embodiments of the present disclosure. The force sensor 400 includes a sensing element 402 (e.g., the sensing element 300 of FIGS. 3A-3B) having three or more integration contact areas 408 protruding from an outer rim of the sensing element 402. FIG. 4B illustrates a perspective view of the force sensor 400 of FIG. 4A including integration contact areas 406, 408 protruding from an outer rim of the sensing element 402. A gap defines two segments. FIG. 4C illustrates an overhead view of the force sensor 400 of FIG. 4A including integration contact areas 404, 406, 408 protruding from an outer rim of the sensing element 402. A gap defines two segments. Integration contact area 408 may be made up of two separated portions 410, 412.

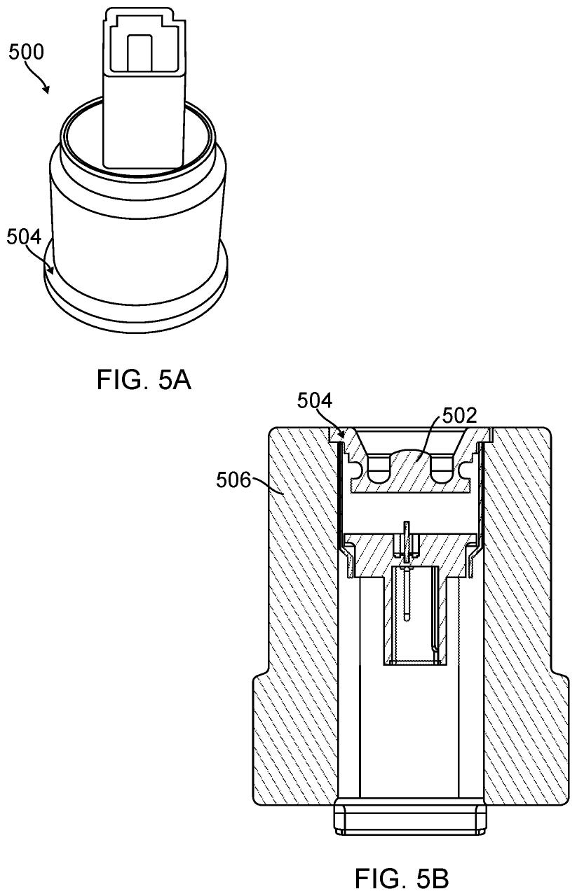

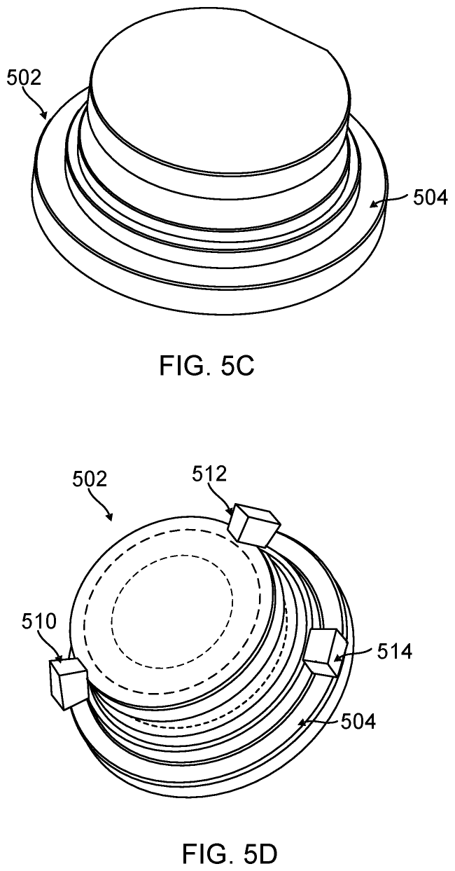

Another example force sensor is a pedal force sensor used to measure a force applied to a vehicle's pedal (e.g., brake or accelerator). FIG. 5A depicts an example pedal force sensor 500, while FIG. 5B depicts a cross section of the pedal force sensor 500 in tooling. The pedal force sensor 500 includes a sensing element 502 having a flat circular support area 504 that provides support between the sensing element 502 and a counterpart such as fixture 506. FIG. 5C sets forth a view of the sensing element 502 that includes the flat circular support area 504. The sensing element 502 may be designed by a finite element analysis (FEA). In an ideal situation or during simulation, there is uniform contact between the support area 504 and the counterpart. However, in practice the interface between the support area and the counterpart is not uniform. Instead, the interface between the support area and the counterpart may occur at random undefined points on the support area. FIG. 5D illustrates undefined support locations 510, 512, 514. Depending on the location of those supports (with respect to the gauge position x-axes) the error may be too high.

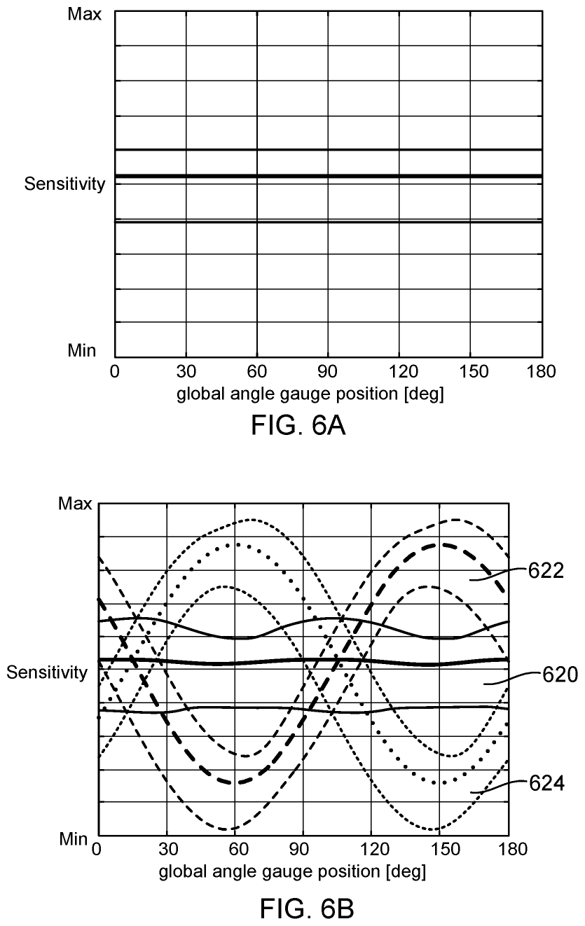

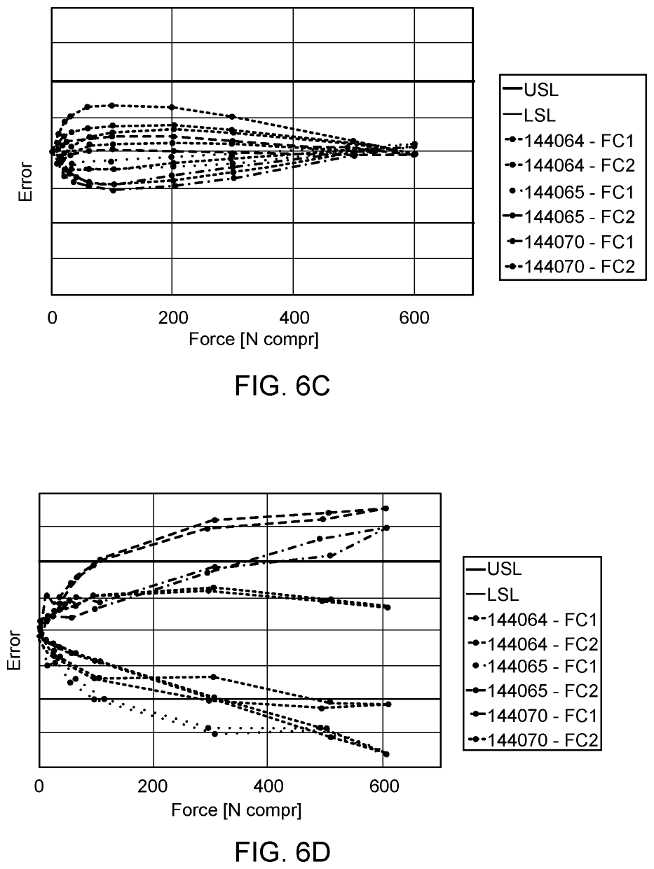

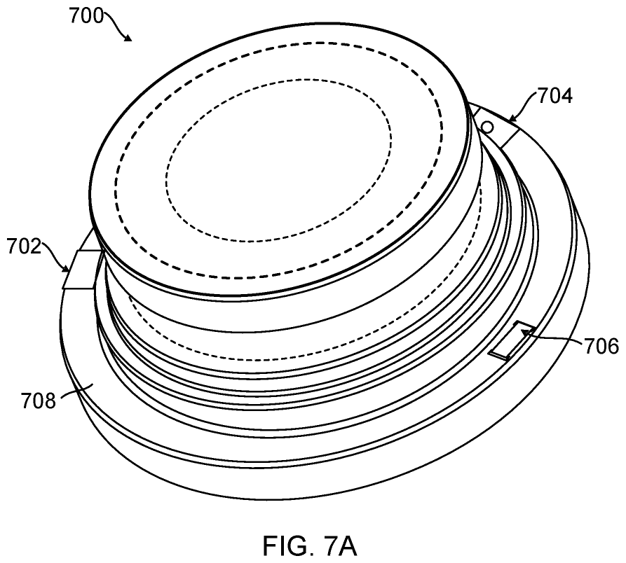

FIG. 6A sets forth a chart of sensor sensitivity vs. the global angle gauge position for the ideal case in which there is uniform contact between the sensor support area 504 and the counterpart. Here, the readings from the full bridge and both half bridge circuits overlap consistently. FIG. 6B sets forth a chart of sensor sensitivity vs. the global angle gauge position for the ‘real-world’ case in which there is not uniform contact between the sensor support area 504 and the counterpart. Here, while the readings 620 from the full bridge are similar to the ideal case, the readings 622, 624 from each half bridge (FC1, FC2) vary greatly based on the angle of the gauges. FIG. 6C sets forth a chart of percent error (Fs) in characterization results in a calibrator (FC1 & FC2). FIG. 6D sets forth a chart of percent error (Fs) in characterization results in application (FC1 & FC2). For the full bridge (FC1 & FC2 combined) the delta between characterization during testing and actual application is small, but there is a clear delta by comparing the individual half bridge signals (FC1 and/or FC2).

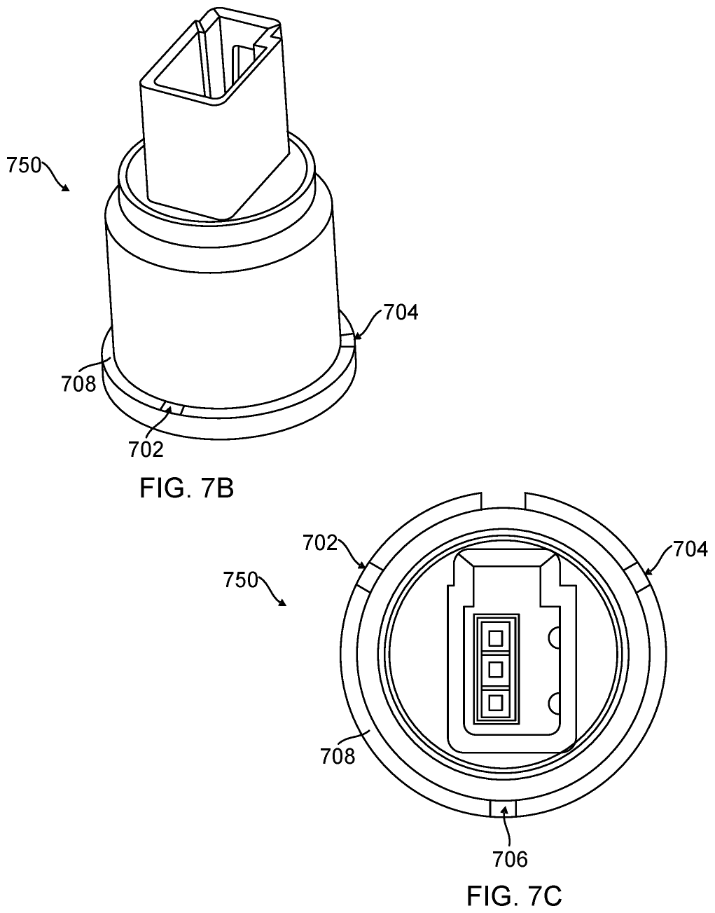

FIG. 7A is a diagram illustrating another sensing element 700 in accordance with some embodiments of the present disclosure. The sensing element 700 is suitable for use in a pedal force sensor, as described above. The sensing element 700 is configured to deform in response to forces applied to the force sensor apparatus such as a pedal force sensor. In a particular embodiment, the sensing element 700 has a first surface arranged to receive a first force. The sensing element 700 deforms in response to the application of one or more forces on a force sensor apparatus. In a particular embodiment, the sensing element 700 is a piece of material, such as metal or plastic, that deforms in response to applications of forces. For example, the sensing element 700 may be a metal disk or a ring-shaped metal disk. The sensing element 700 may include one or more steps, rims, or lips (as depicted) for supporting stacked components such as a printed circuit board (PCB) support structure, sensor housing, or other components. Readers of skill in the art will realize that the sensing element 700 may be produced using a variety of methods and techniques including but not limited to turned and milled and metal injection molding.

The sensing element includes sensing gauges (not shown) coupled to the sensing element 700. In a particular embodiment, the top surface of the sensing element 700 is prepared to provide a good attachment surface for the sensing gauges. For example, the top surface of the sensing element 700 may be sand-blasted. Each of the sensing gauges is configured to generate a signal indicating the degree that the sensing element 700 deforms in response to the application of forces on the sensor. In a particular embodiment, the sensing gauges are micro-fused strain gauges (MSG). In order to measure the amount of force applied to the sensing element, the sensing gauges may be evenly distributed on a circle on a top surface of the sensing element 700. Readers of skill in the art will realize that any number of sensing gauges may be used in accordance with the present disclosure (including a particular embodiment in which a single gauge is used as the sensing gauges).

The sensing element 700 further includes a circular support area 708 at the base of the sensing element. A fixture (not shown here) interfaces with the support area 708 and supports the sensor apparatus when inserted into the fixture.

In some embodiments in accordance with the present disclosure, sensor error is reduced by minimizing the parasitic forces on the sensing element due to non-uniform forces acting on the support area of the sensing element. In these embodiments, the sensing element 700 includes defined support locations. Unlike the flat circular support area 504 of the sensing element 502 depicted in FIG. 5A, the sensing element 700 of FIG. 7 includes three or more defined support contact areas 702, 704, 706 in the support area 708 of the sensing element 700. In some examples, the defined support contact areas 702, 704, 706 are protrusions in the support area 708. In some examples, the defined support contact areas 702, 704, 706 are machined in the sensing element 700. By providing the support contact areas 702, 704, 706 in the sensing element 700, the sensing gauges can be positioned in such way that the impact of parasitic forces is zero. This is the crossing point between the readings 620, 622, 624 in FIG. 6D (i.e., the intersection of the full bridge, the first half bridge (FC1), and the second half bridge (FC2) readings). At that point, the half bridges are giving the same output as the full bridge and those contact/supporting locations will also not change between initial calibration and application. FIG. 7B sets forth a front view of an example pedal force sensor apparatus 750 that incorporates the sensing element 700 of FIG. 7A. The sensing element support area 708 includes the support contact areas 702, 704. FIG. 7B sets forth an overhead view of the example pedal force sensor apparatus 750 that incorporates the sensing element 700 of FIG. 7A. The support area 708 includes the defined support contact areas 702, 704, 706.

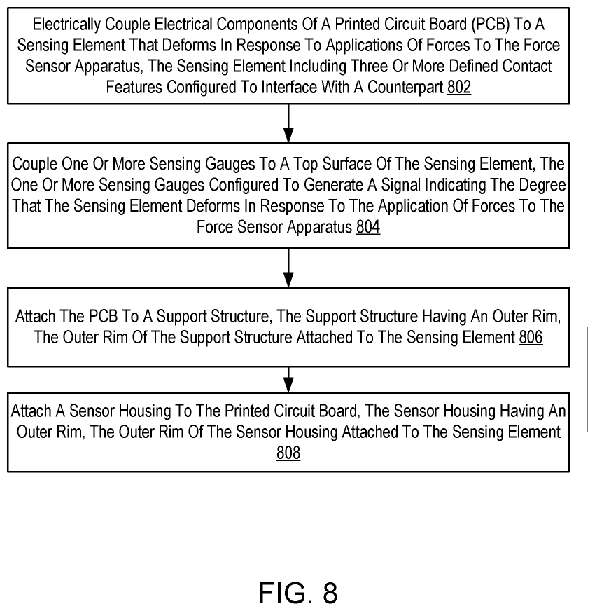

For further explanation, FIG. 8 sets forth a flowchart to illustrate an implementation of a method of assembling a force sensor apparatus according to embodiments of the present disclosure. The method of FIG. 8 includes electrically coupling (802) electrical components of a printed circuit board (PCB) to a sensing element that deforms in response to applications of forces to the force sensor apparatus. In the example of FIG. 8, the sensing element includes three or more defined contact features configured to interface with a counterpart. Electrically coupling (802) the electrical components of the PCB to the sensing element may be carried out by connecting an electrical connection (e.g., a wirebond) from the PCB to the sensing element.

The method of FIG. 8 also includes coupling (804) one or more sensing gauges to a top surface of the sensing element. In the example of FIG. 8, the one or more sensing gauges are configured to generate a signal indicating the degree that the sensing element deforms in response to the application of forces to the force sensor apparatus.

The method of FIG. 8 includes attaching (806) the printed circuit board (PCB) having electrical components to a support structure. Attaching (806) the printed circuit board (PCB) having electrical components to the support structure may be carried out by soldering or applying an adhesive, tape, or glue to the bottom of a PCB to the support structure.

The method of FIG. 8 also includes attaching (808) a sensor housing to the printed circuit board, the sensor housing having an outer rim, the outer rim of the sensor housing attached to the sensing element. Attaching (808) a sensor housing to the printed circuit board may be carried out by coupling the sensor housing to the PCB.

The flowchart and diagrams in the Figures illustrate the architecture, functionality, and operation of possible implementations of apparatus and methods according to various embodiments of the present disclosure. In some alternative implementations, the functions noted in the blocks or step in the method may occur out of the order noted in the figures. For example, two blocks shown in succession may, in fact, be performed substantially concurrently, or the blocks may sometimes be performed in the reverse order, depending on the functionality involved.

Advantages and features of the present disclosure can be further described by the following statements:

1. A force sensor apparatus comprising: a sensing element that deforms in response to applications of forces to the force sensor apparatus, the sensing element including three or more defined contact features configured to interface with a counterpart; and one or more sensing gauges coupled to a top surface of the sensing element and configured to generate a signal indicating the degree that the sensing element deforms in response to the application of forces to the force sensor apparatus.

2. The force sensor apparatus of statement 1, wherein the three or more defined contact features decouple integration forces from forces measured by force sensor apparatus.

3. The force sensor apparatus of statement 1 or 2, wherein the three or more defined contact features minimize an impact of parasitic forces.

4. The force sensor apparatus of any of statements 1-3, wherein the three or more defined contact features are defined integration contact areas that protrude from an outer rim of the sensing element.

5. The force sensor apparatus of any of statements 1-4, wherein the sensing element is a segmented press-fit sensing element.

6. The force sensor apparatus of any of statements 1-5, wherein the three or more defined contact features are defined support contact areas.

7. The force sensor apparatus of any of statements 1-6, wherein the three or more defined contact areas are protrusions in a support area of the sensing element.

8. The force sensor apparatus of any of statements 1-7, wherein the one or more sensing gauges are micro-fused strain gauges.

9. The force sensor apparatus of any of statements 1-8, further comprising: a printed circuit board configured to receive the signal from the one or more sensing gauges; a support structure having a surface on which the printed circuit board is coupled, the support structure having an outer rim, the outer rim of the support structure attached to the sensing element; and a sensor housing that covers the printed circuit board, the sensor housing having an outer rim, the outer rim of the sensor housing attached to the sensing element.

10. A method of assembling a force sensor apparatus, the method comprising: electrically coupling electrical components of a printed circuit board (PCB) to a sensing element that deforms in response to applications of forces to the force sensor apparatus, the sensing element including three or more defined contact features configured to interface with a counterpart; and coupling one or more sensing gauges to a top surface of the sensing element, the one or more sensing gauges configured to generate a signal indicating the degree that the sensing element deforms in response to the application of forces to the force sensor apparatus.

11. The method of statement 10, wherein the three or more defined contact features decouple integration forces from forces measured by force sensor apparatus.

12. The method of statement 10 or 11, wherein the three or more defined contact features minimize an impact of parasitic forces.

13. The method of any of statements 10-12, wherein the three or more defined contact features are defined integration contact areas that protrude from an outer rim of the sensing element.

14. The method of any of statements 10-13, wherein the sensing element is a segmented press-fit sensing element.

15. The method of any of statements 10-14, wherein the three or more defined contact features are defined support contact areas.

16. The method of any of statements 10-15, wherein the three or more defined contact areas are protrusions in a support area of the sensing element.

17. The method of any of statements 10-16, wherein the one or more sensing gauges are micro-fused strain gauges.

18. The method of any of statements 10-17, further comprising: coupling the PCB to a support structure, the support structure having an outer rim, the outer rim of the support structure attached to the sensing element.

19. The method of any of statements 10-18, further comprising coupling a sensor housing to the printed circuit board, the sensor housing having an outer rim, the outer rim of the sensor housing attached to the sensing element.

20. The method of any of statements 10-19, wherein the sense element is ringed shaped.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A force sensor apparatus, comprising:
a sensing element that deforms in response to applications of forces to the force sensor apparatus, the sensing element including three or more defined contact features configured to interface with a counterpart; and
one or more sensing gauges coupled to a top surface of the sensing element and configured to generate a signal indicating the degree that the sensing element deforms in response to the application of forces to the force sensor apparatus.

2. The force sensor apparatus of claim 1, wherein the three or more defined contact features decouple integration forces from forces measured by force sensor apparatus.

3. The force sensor apparatus of claim 1, wherein the three or more defined contact features minimize an impact of parasitic forces.

4. The force sensor apparatus of claim 1, wherein the three or more defined contact features are defined integration contact areas that protrude from an outer rim of the sensing element.

5. The force sensor apparatus of claim 4, wherein the sensing element is a segmented press-fit sensing element.

6. The force sensor apparatus of claim 1, wherein the three or more defined contact features are defined support contact areas.

7. The force sensor apparatus of claim 6, wherein the three or more defined contact areas are protrusions in a support area of the sensing element.

8. The force sensor apparatus of claim 1, wherein the one or more sensing gauges are micro-fused strain gauges.

9. The force sensor apparatus of claim 1, further comprising:
a printed circuit board configured to receive the signal from the one or more sensing gauges;
a support structure having a surface on which the printed circuit board is coupled, the support structure having an outer rim, the outer rim of the support structure attached to the sensing element; and
a sensor housing that covers the printed circuit board, the sensor housing having an outer rim, the outer rim of the sensor housing attached to the sensing element.

10. A method of assembling a force sensor apparatus, the method comprising:
electrically coupling electrical components of a printed circuit board (PCB) to a sensing element that deforms in response to applications of forces to the force sensor apparatus, the sensing element including three or more defined contact features configured to interface with a counterpart; and
coupling one or more sensing gauges to a top surface of the sensing element, the one or more sensing gauges configured to generate a signal indicating the degree that the sensing element deforms in response to the application of forces to the force sensor apparatus.

11. The method of claim 10, wherein the three or more defined contact features decouple integration forces from forces measured by force sensor apparatus.

12. The method of claim 10, wherein the three or more defined contact features minimize an impact of parasitic forces.

13. The method of claim 10, wherein the three or more defined contact features are defined integration contact areas that protrude from an outer rim of the sensing element.

14. The method of claim 13, wherein the sensing element is a segmented press-fit sensing element.

15. The method of claim 10, wherein the three or more defined contact features are defined support contact areas.

16. The method of claim 15, wherein the three or more defined contact areas are protrusions in a support area of the sensing element.

17. The method of claim 10, wherein the one or more sensing gauges are micro-fused strain gauges.

18. The method of claim 10, further comprising:
attaching the PCB to a support structure, the support structure having an outer rim, the outer rim of the support structure attached to the sensing element.

19. The method of claim 10, further comprising:
attaching a sensor housing to the PCB, the sensor housing having an outer rim, the outer rim of the sensor housing attached to the sensing element.

20. The method of claim 10, wherein the sensing element is ring shaped.
